(19) United States
(12) Patent Application Publication
(10) Pub. No.: US 2014/0022058 A1
(43) Pub. Date: Jan. 23, 2014

(54) Apparatus and Method for Providing Product Information

(71) Applicant: The Gillette Company, Boston, MA (US)

(72) Inventors: Grant Edward Striemer, Hamilton, OH (US); Jonathan Livingston Joyce, Independence, KY (US); Mathias Amann, Darmstadt Hessen (DE); Faiz Feisal Sherman, Mason, OH (US); Michael Franke, Darmstadt (DE); Jordan Todorov Bourilkov, Bethany, CT (US); Mark Wayne Morrow, Milford, OH (US); Jose Tadeo Vergara DeCastro, Newton, MA (US); Stephan James Andreas Meschkat, Bad Soden Hessen (DE)

(73) Assignee: The GIllette Company, Boston, MA (US)

(21) Appl. No.: 14/025,864

(22) Filed: Sep. 13, 2013

Related U.S. Application Data
(63) Continuation-in-part of application No. 13/616,402, filed on Sep. 14, 2012.
(60) Provisional application No. 61/580,379, filed on Dec. 27, 2011.

(51) Int. Cl. G06K 7/00; G06Q 30/06

(52) U.S. Cl. CPC G06K 7/0008; G06Q 30/0623
USPC 340/10.1

(57) ABSTRACT

A sensor system comprises a tag. The tag comprises at least one radio-frequency chip and a first antenna. The chip comprises a memory element, the memory element comprising electrical storage of a binary coded word comprising at least one bit, and output terminals. The tag further comprises at least one conductive polymeric system disposed in electrical communication with at least one output terminal of the chip and adapted to change electrical state in association with a predetermined change in an environment of the conductive polymeric system. The first antenna is disposed in electrical communication with the output terminal(s) of the chip and the conductive polymeric system.

### FIELD OF THE INVENTION

The invention relates to systems and methods for determining information about a product. The invention relates particularly to the remote interrogation of product information and the subsequent use of the acquired information.

### BACKGROUND OF THE INVENTION

Consumable goods having a useful life defined in terms of the consumption of the goods are well known. The useful life may be viewed as one or more events associated with the consumption of at least a portion of the useful quantity of the goods. In formation associated with the environment of use of the goods and/or the quantity of goods used and remaining available may exist but may also be generally inaccessible to the typical consumer of the goods. What is needed is a system and method for extracting product relevant information in a manner which makes the information readily accessible and usable by the consumer.

### SUMMARY OF THE INVENTION

In one aspect, a sensor system comprises a tag. The tag comprises at least one radio-frequency chip and a first antenna. The chip may be an active or a passive chip. The chip comprises a memory element, the memory element comprising electrical storage of a binary coded word comprising at least one bit, and output terminals. The tag further comprises at least one conductive polymeric system disposed in electrical communication with at least one output terminal of the chip and adapted to change electrical state in association with a predetermined change in an environment of the conductive polymeric system. The first antenna is disposed in a circuit also comprising the chip and the conductive polymeric system.

In one aspect a method of determining product information includes the steps of: providing a product comprising a tag, and an interrogator adapted to detect radiation associated with the data of the tag; interrogating the state of the tag; interpreting the state of the tag; and providing an output associated with the interpreted state of the tag. The tag comprises a digital memory storing data associated with the product.

### BRIEF DESCRIPTION OF THE DRAWINGS

Further features and benefits of the present invention will become more readily apparent through consideration of the drawings.

FIG. 1 shows a schematic representation of one embodiment of the invention.

FIG. 2 show s a schematic representation of one embodiment of the invention.

FIG. 3 shows a schematic representation of one embodiment of the invention.

### DETAILED DESCRIPTION OF THE INVENTION

### Definitions

The following text sets forth a broad description of numerous different embodiments of the present invention. The description is to be construed as exemplary only and does not describe every possible embodiment since describing every possible embodiment would be impractical, if not impossible, and it will be understood that any feature, characteristic, component, composition, ingredient, product, step or methodology described herein can be deleted, combined with or substituted for, in whole or part, any other feature, characteristic, component, composition, ingredient, product, step or methodology described herein. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). No term is intended to be essential to the present invention unless so stated. To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

A “chip” as described herein, may be supplanted by a chipless RFID element as is known in the art. An LC resonant RF tag, or a multiresonator element may be used in place of the chip in the described embodiments.

In one aspect, a sensor system comprising a tag. The tag may comprise one or more layers of conductive inks and non-conductive inks printed upon a substrate. Exemplary substrate materials include: polymer films, paper, high permittivity dielectric materials, and FR-4 material. Multiple layer structures may further comprise partial layers of non-conducting material separating at least portions of the conductive layers. Exemplary conductive layers include copper and silver inks. The tag comprises at least one radio-frequency chip, a first antenna disposed as a circuit upon a card, coin, or inlay. Exemplary chip/first antenna combinations include model numbers: RI-I03-112A-03 (13.56 MHz), and RI-INL-R9QM (134.2 kHz), or model TRF7970A, each available from Texas Instruments, Dallas, Tex. The antenna may be in the physical form of a coil or a dipole, or may comprise a conductive component of a product or package in electrical communication with the remainder of the tag. The chip/first antenna combination may be integrated into a unit tag available from Kovio, San Jose, Calif. The tag further comprises a conductive polymeric system in electrical communication with the chip and the antenna.

The needed power supply for the tag may be provided by the harvested energy of the RFID circuit because the needed current is in the micro ampere range. The harvested power may be stored with an element such as a capacitor for use by the tag at a later time.

The sensor system also comprises at least one conductive polymer system. The conductive polymer may comprise a polymer coating configured such that the coating ceases to be conductive as or after it is insulted or exposed to an environmental change of a predetermined type. Exemplary environmental changes include: humidity changes, exposure to moisture, exposure to particular chemicals or chemical properties such as pH, changes in environmental temperatures, etc. Alternatively, the polymer system may comprise a polymer coating which becomes conductive as or after the environmental insult. The conductive polymer system may be used to form portions of the circuitry of the tag including input and output leads or the antenna or a portion of the antenna.

In one embodiment, the environmental change results in a change in the dimensions of the polymer system via swelling or shrinkage due to the change in the environment.

The circuit arrangement of the tag may be configured to provide positive or negative feedback in association with the environmental insult according to the type of polymer system utilized and the physical arrangement of the circuit elements.

In one embodiment, the circuit is configured with a gap in the circuit such that absent an additional element, the circuit will be open and any effort to interrogate the tag will yield no output from the tag. In this embodiment, the gap may be covered by a polymer system which is conductive until insulted yielding a tag which will change state from readable to unreadable as or after the environmental insult occurs (the tag shuts down, considered negative feedback). Alternatively, the gap may be coated with a polymer system which changes from non-conductive to conductive in response to the environmental change (the tag becomes readable, positive feedback to the insult).

In one embodiment, the tag may be configured with a polymer system arranged such that the insult will alter the state of the tag from off to on using the conductive to non-conductive polymer system, or from on to off using the polymer system which transitions from on to off as or after the insult occurs. In this embodiment, the polymer system may be disposed as a coating across two legs of the circuit effective shorting those legs together and bypassing the remainder of the circuit. As an example, if a coating is disposed across two leads from the chip to the antenna, the conductive coating will short the circuit such that upon interrogation, the chip will receive no power and the interrogator will receive no output from the tag. As or after the insult, the coating will transition from on to off removing the short in the circuit and allowing power to pass from the antenna to the chip resulting a readable tag.

In a tag having a similarly disposed polymer coating but utilizing the polymer which transitions from non-conductive to conductive as or after it is insulted, the tag will transition from on—prior to the insult—to off—as or after being insulted.

It is also possible to configure a more elaborate tag comprising dual chips and dual antennae, or dual chips and a single antenna, wherein a first chip-antenna combination will transition from on to off while the second chip-antenna combination will transition from off to on as or after the tag is subjected to a single environmental insult. To ease the burden associated with manufacturing such a tag system, one chip antenna pair may comprise a gap while the other comprises a coating across the antenna lead pair. In this configuration the same polymer system may be disposed on both the gap and the antenna leads to achieve a dual state readable tag regardless of the polymer selected.

Alternatively, the dual tag may comprise identical pairs of chip-antenna combinations and the difference in readable state may be accomplished by coating one chip-antenna combination with a polymer switching from on to off as or after insulted, while coating the second chip-antenna combination with a polymer which will switch from off to on as or after the same insult occurs.

The polymer system which transitions from on to off as or after it is insulted comprises a polymer matrix and conductive filler. The polymer has the capability to expand to about 120%-140%, or more, of its un-insulted volume as or after the insult. The expansion may not, and need not be instantaneous for the functionality of the tag to be useful. The insult must persist long enough for the polymer system to react by absorbing the liquid or humidity of the insult resulting in the change in conductivity.

The polymer system may comprise a solution of water, Triton X-100, polyvinyl alcohol and silver-coated copper flakes. The solution may be applied to the portions of the tags described above and placed in a desiccant chamber to dry the coating upon the tag.

The polymer system may be configured to expand in the presence of water, humidity or alternatively to remain stable in the presence of water while changing state in the presence of non-aqueous liquids in the environment.

In one aspect the polymer system may comprise a solution of trichloroethylene, polyethylene co-vinyl acetate, and silver-coated copper flakes. The solution is disposed upon the tag as described above and dried.

The polymer system may also be configured such that it will change state from non-conductive to conductive as or after insult. Again, the change may not and need not be instantaneous to be of use. In this aspect the polymer system may comprise water, polyvinyl alcohol and sodium chloride disposed as a coating. Though initially non-conducting, upon exposure to humidity or water, the electrolytes become soluble in the swelling polymer yielding a now conductive coating.

The tag may be read using an radio frequency protocol such as the Near Field Communications (NFC) protocol. When the tag is interrogated, or read, the tag circuit is powered. The memory of the tag is then read by an interrogator.

The relevant communications frequency range of the tag may be HF, UHF or other appropriately selected frequency ranges as determined by the specific need of the tag in terms of the intended environment and uses of the tag.

The sensor system may further comprise an interrogator. The interrogator comprising a power source and a second antenna adapted to generate electromagnetic radiation comprising a resonant frequency of the first antenna, and a receiver adapted to detect electromagnetic radiation and de-modulate the detected radiation extracting embedded data from the detected radiation. The Bluetooth™ RFID Reader, model number 223012, available GAO RFID, of Toronto Canada, exemplifies one form of interrogator. The model 223012 interrogator has the capacity to interrogate the radio frequency tag and to determine the state of the memory of the tag and thus extract information associated with the output of the sensor or sensors relating to the environment of the tag. The 223012 further comprises a secondary network communications link utilizing the Bluetooth™ communications protocol for transmitting the information extracted from the tag to a secondary device or secondary interrogator, such as a Bluetooth™ enabled computer or smart phone. The secondary interrogator may further analyze the information relating to the state of the tag and/or the tags environment and provide an output associated with a particular tag and/or tag environment state. The interrogator may further comprise a display element such as an LCD or LED screen for displaying an output associated with the analyzed tag information. The interrogator may further comprise one or more sensors for ascertaining information associated with the environment of the interrogator. The sensors may include: temperature, humidity, acceleration sensors. The interrogator may further comprise one or more cameras enabling the capture of images associated with a product, the tag or the environment. The interrogator may comprise a Global Positioning capability enabling the interrogator to ascertain and share information relating to the geographic location of the interrogator.

In one aspect, the smart phone may serve as the only interrogator. In this aspect the smart phone may interrogate the tag thereby ascertaining the information from the memory of the tag. The interrogator may analyze or otherwise interpret the information and may create an output. The output may be provided to a system user via an audio output, visual output, haptic output or combinations thereof. The interrogator may utilize inputs from sensors or systems of the smart phone, including information and analysis available from a networked resource such as cloud computing resources, Exemplary smart phones suitably configured to perform as a system interrogator include: the Acer™ E320 Liquid Express, the Blackberry™ Bold 970, available from Research In Motion of; the Casio IT-800; the Google Nexus 7™, available from Google, Inc. Mountain View Calif.; the HTC Desire C™, available from HTC of; the LG Optimus Elite; the Motorola Droid™ Razr™, available from Motorola; the Nokia 700; the Panasonic BizPad™; and the Samsung Galaxy S Advance™.

In one aspect, the sensor system may include a product. The term “product(s)” is used in the broadest sense and refers to any product, product group, services, communications, entertainment, environments, organizations, systems, tools, and the like. For example, an example of a product group is personal and household products, such as used by a person, family or household. Examples of a representative, and non-limiting list of product categories within the personal and household product group includes antiperspirants, baby care, colognes, commercial products (including wholesale, industrial, and commercial market analogs to consumer-oriented consumer products), cosmetics, deodorants, dish care, feminine protection, hair care, hair color, health care, household cleaners, laundry, oral care, paper products, personal cleansing, disposable absorbent articles, pet health and nutrition, prescription drugs, prestige fragrances, skin care, foods, snacks and beverages, special fabric care, shaving and other hair growth management products, small appliances, devices and batteries, services such as haircutting, beauty treatment, spa treatment, medical, dental, vision services, entertainment venues such as theaters, stadiums, as well as entertainment services such as film or movie shows, plays and sporting events A variety of product forms may fall within each of these product categories.

Exemplary product forms and brands are described on The Procter & Gamble Company's website www.pg.com, and the linked sites found thereon. It is to be understood that consumer products that are part of product categories other than those listed above are also contemplated by the present invention, and that alternative product forms and brands other than those disclosed on the above-identified website are also encompassed by the present invention.

Exemplary products within the laundry category include detergents (including powder, liquid, tablet, and other forms), bleach, conditioners, softeners, anti-static products, and refreshers (including liquid refreshers and dryer sheets). Exemplary products within the oral care category include dentifrice, floss, toothbrushes (including manual and powered forms), mouth rinses, gum care products, tooth whitening products, and other tooth care products. Exemplary feminine protection products include pads, tampons, interlabial products, and pantiliners. Exemplary baby care products include diapers, wipes, baby bibs, baby change and bed mats, and foaming bathroom hand soap.

Exemplary health care products include laxatives, fiber supplements, oral and topical analgesics, gastro-intestinal treatment products, respiratory and cough/cold products, heat delivery products, and water purification products. Exemplary paper products include toilet tissues, paper towels, and facial tissues. Exemplary hair care products include shampoos, conditioners (including rinse-off and leave-in forms), and styling aids. Exemplary household care products include sweeper products, floor cleaning products, wood floor cleaners, antibacterial floor cleaners, fabric and air refreshers, and vehicle washing products. Skin care products include, but are not limited to, body washes, facial cleansers, hand lotions, moisturizers, conditioners, astringents, exfoliation products, micro-dermabrasion and peel products, skin rejuvenation products, anti-aging products, masks, UV protection products, and skin care puffs, wipes, discs, clothes, sheets, implements and devices (with or without skin care compositions).

Other product groups include but are not limited to: sports equipment, entertainment (books, movies, music, etc), vision, and in-home-consumed medical and first aid, among others.

The tag may be attached to the packaging of the product such as the primary packaging of a liquid product, or a granular product. The tag may be immersed in or float upon the surface of a packaged liquid or granular product. The tag may be incorporated within the product such as within a disposable absorbent article such as within a diaper for the purpose of detecting an insult to the absorbent core of the diaper. The tag may be disposed upon the surface of the product itself.

It is believed that conforming the antenna of the tag to the shape of the outer surface of the product yields a system where communication between the interrogator and the tag may be omni-directional or achievable at a variety of angles between the interrogator and the tag.

One of the problems associated with creating a communication device for various products is realized when the communication device is utilized on electromagnetically conductive bodies. Free space radio propagation principles do not apply near highly conductive bodies. Additionally, antenna performance is severely degraded when antennas are placed near metals. As such, simply placing an RFID tag on a battery or on an object with a conductive body may not accomplish the desired effect, e.g. power harvesting and/or data transfer. Notably, this problem is not limited to rechargeable/disposable batteries. For example, a can of shaving gel, foam, etc., or a package comprising a metalized film, could experience the same issues because of the conductivity of the container. In general, an RFID tag next to metallic body decreases signal coupling between the reader and the tag by 10×.

One way to prevent the effects arising from metal proximity to the antenna is to prevent the electromagnetic field from entering the metal. For example, separating the antenna and the metal surface by placing a material with suitable electromagnetic properties and dimensions between them may divert the electromagnetic field around the metallic/conductive body of the product. The properties of the diverter material depend on the exact metal used and the RFID frequency. The magnetic diverter effectively isolates the tag from the can. An effective separation may also be achieved with an air filled gap between the materials.

In one aspect, a method of determining product information comprises steps of: providing a product comprising a tag as described above. The tag comprises at least one radio-frequency chip and a first antenna. The chip comprises a memory element, the memory element comprising electrical storage of a binary coded word comprising at least one bit, and output terminals. The tag further comprises at least one conductive polymeric system disposed in electrical communication with at least one output terminal of the chip and adapted to change electrical state in association with a predetermined change in an environment of the conductive polymeric system. The first antenna is disposed in a circuit also comprising the chip and the conductive polymeric system.

The method also includes providing an interrogator adapted to detect radiation associated with the data of the tag. The interrogator may be an RF or NFC protocol reader coupled with a Bluetooth™ capability as described above, or a smart phone or other computing device comprising an RF or NFC capable reader.

The interrogator may be used to determine the current state of the tag utilizing an RF communications protocol such as the NFC protocol. The interrogator may interpret the data received from the tag using a software application written for that purpose.

In one aspect, the interrogator may incorporate a secondary network communication module affording the device an ability to send and receive data over a cellular phone or other networks including a local area or WiFi networks. In such an aspect, the interrogator may transmit data received from the tag and/or an analysis of the data from the tag. The software application of the interrogator may analyze the data from the tag to determine if replenishment of the product associated with the tag in needed, or to project when such replenishment will be needed in view of usage history of the product established via a series of interrogations of the tag. In this aspect the application may be used to consummate a purchase of addition product via the network. The application may be further utilized to offer the user related products for purchase, or to make offers of other products not directly related to the product.

The system and methods may be utilized to provide event information associated with consumer products. The system may be embedded within an absorbent product such as a diaper or feminine care product such that polymer system will interact with the absorbed fluids altering the state of the tag and enabling a user of the method to detect the altered state of the tag. The system tag may be configured as part of a package in contact with the packaged product such that use and consumption of the product will lead to removal of the product in contact with the polymer system, changing the state of the tag and enabling detection of this event and change of state.

In one embodiment, a circuit may be configured with two antenna elements which are separated by a gap. In the absence of a conductive gap filling material, the antenna are not coupled. The design of the antenna may be such that a first antenna connected to the remainder of the tag, is insufficient to adequately power the tag when interrogated. The combination of the two antennae and a coupling gap filling element may be sufficient and will lead to a successful interrogation of the tag indicating the presence of the gap filling material of interest.

In one embodiment, a circuit gap may be partially filled with a polymer element adapted to expand in the presence of an appropriate environmental change. A polymer, such as poly(pyrrole), poly(acetylene), or poly(aniline) may be used to partially fill a circuit gap. Upon exposure of the exposed polymer to an environment comprising a solvent having a solubility parameter similar to that of the tag polymer, the tag polymer will swell, filling the gap and completing the circuit rendering the tag operational due to the environmental change.

### Examples of Coatings

A polyelectrolyte coating with high salt content was developed as follows. A vial was filled with 10 mL of ultra filtered deionized water. 1.1688 grams of sodium chloride was added to the vial and mixed with a magnetic stir bar at room temperature until the salt dissolved resulting in a 2 molar salt solution. When the system appeared clear, 0.3 grams of poly(vinyl alcohol) was added. The solution was heated to 90° C. allowing the polymer to go into solution. When the system cleared it was ready to be applied to the surface using 10 microliter pipette tips with approximately 1-2 millimeters of the tips removed. The pipette was set to 5 microliters and the hot polymer solution was applied to the area of interest on the RFID tag. The system was then placed into a desiccant chamber and allowed to dry at room temperature overnight.

A chemiresistor polymer coating was developed as follows. A vial was filled with 9 mL of ultra filtered deionized water. A separate vial was used to add 0.1 grams of triton X100 to 10 milliliters of ultra filtered deionized water for a 1% by weight solution. 1 milliliter of the 1% by weight Triton X-100 was added to the 9 milliliters of ultra filtered deionized water for a 0.1% by weight Triton X-100 solution. 0.3 grams of poly(vinyl alcohol) was added to the 0.1% by weight Triton X-100 solution, add (lower MW and higher % hydrolysis makes the system respond faster than the higher MW and lower % hydrolysis). The solution was heated to 90° C. allowing the polymer to go into solution. When the system cleared, 0.1 grams of the silver coated copper (AgCU550) conductive filler, available from Ferro Electronic Materials Systems, of Mayfield Heights, Ohio, was added. The solution was sonicated (degas mode, level 5) for 5 minutes. The system was applied to the surface using 10 microliter pipette tips with approximately 1-2 millimeters of the tips removed. The pipette was set to 5 microliters and the hot polymer solution was applied to the area of interest on the RFID tag. The system was then placed into a desiccant chamber and allowed to dry at room temperature overnight.

A second chemiresistor polymer coating designed to respond not to water but instead to other environmental chemicals was developed as follows. A vial was filled with 10 mL of Trichloroethylene. 0.6 grams of [poly(ethylene co-vinyl acetate] was added to the vial. The solution to mix at room temperature until the polymer went into solution. When the system was clear, 0.2 grams of the silver coated copper (AgCU550) conductive filler was added. The system was applied to the surface using 10 microliter pipette tips with approximately 1-2 millimeters of the tips removed. The pipette was set to 5 microliters and the hot polymer solution was applied to the area of interest on the RFID tag. The system was then placed into a fume hood and allowed to dry at room temperature overnight.

A chemiresistor polymer system designed to respond only to an environment having a pH within a target range was developed as follows: The method may use either Talc as the anti-tacking agent and triethyl citrate as the plasticizer or PlasACRYL HTP20 as the anti-tacking/plasticizer. In a 200 mL beaker, 41.7 mL of Eudragit L30 D-55, available from Evonik Industries, Essen, Germany, was added to 57 mL of deionized water, 14.6 mL of PlasACRYL HTP20, available from Evonik Industries, and 4.3 grams of the silver coated copper (AgCU550) conductive filler. The solution was mixed with a magnetic stir bar for 10 minutes. The solution was used to coat the desired area of the RF tags and cured in a circulating drying oven for 2 hours at 40° C. The RFID tag turned off when the polymer was exposed to an environment having pH values greater than 5.5.

A polymeric system sensitive to mechanical strain was developed by substituting an elastic polymer for the environmentally sensitive polymer as follows: 8 grams of silicone RTV rubber was mixed with 8 grams of conductive filler in a beaker to obtain a 50/50 ratio of polymer. The mixture was extruded through a plastic 20 mL syringe. The strips were extruded onto a silicone surface for easy removal. The room temperature vulcanization was allowed to proceed for 24 hours. The strain sensor strip was removed and tested for dynamic conductivity and mechanical properties (Young's modulus, elastic region, Yield point). The Instron was set to constant extension at 1 mm/sec until break. The resistance was measured in parallel with a 2831E Measurement (Data Logging Multimeter) and small alligator clips attached to the sample. The Young's modulus was calculated with the Instron software. A secondary test was conducted without alligator clips where the final strain of 150% strain from extension where the break occurred in the middle of the strain sensor.

In one embodiment, the system tag may be subdivided into portions. One portion may contain at least a portion of the antenna and the chip, the other portion may contain the conductive polymer system and any remaining portion of the antenna. The two portions of the tag may be disposed with the polymer exposed to the functional environment of an absorbent article, and the antenna and chip portion removed from exposure to the functional environment of the article. The antenna and chip portion may be made removable and therefore reusable as well. The sensor may be made removable while the antenna and chip portion is retained in the product. In one embodiment, a removable sensing element may be coupled to a resident chip/antenna element. As an example, a personal care device such as a shaver or oral care implement, may be constructed with a resident antenna and chip with contacts enabling the insertion use and removal of a sensing element. The sensing element may be removed for disposal or replacement or cleaning and reinstallation. In one embodiment, conductive hook and loop fasteners, such as are available from APLIX Inc., of Charlotte, N.C., may be used to create an interface between the functional environment of the article and the exterior of the article. The attachment mechanism between the article, sensor and the removable tag to enable conductivity can be hook & loop, compression (e.g. elastic band, garter), adhesion (e.g. adhesive strip), magnetic, or combinations thereof. In this embodiment, the polymer system may be fabricated as an assembly in electrical contact with the conductive hook and loop pads which in turn are disposed upon an exterior surface of the article while the conductive polymer is disposed within the interior of the article. Matching pads may be incorporated as part of the assembly of the antenna and chip assembly and the two respective assemblies may be united using the matching hook and loop pads for operational use of the tag. In this manner, the more costly antenna and chip assembly may be rendered reusable thereby reducing the overall cost associated with using the system with a number of respective disposable articles. The respective assemblies may be formed using conductive adhesive, such as is available from MG Chemicals, of Surrey, B.C., Canada to affix the electrical leads of the respective portions of the tags to their respective hook and loop fastener pads.

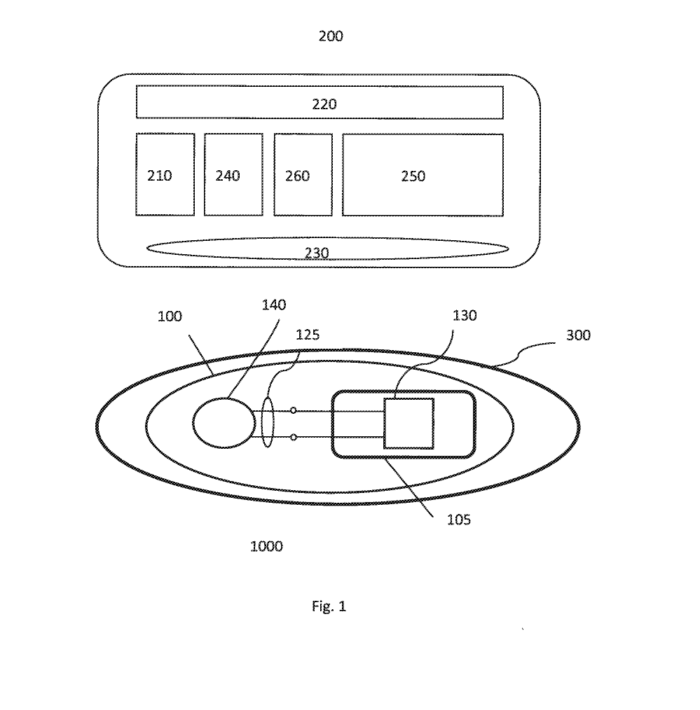

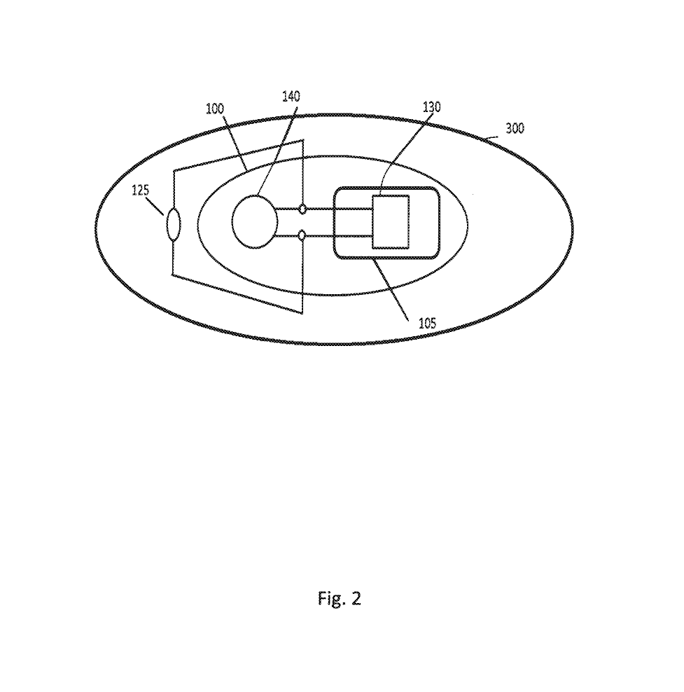

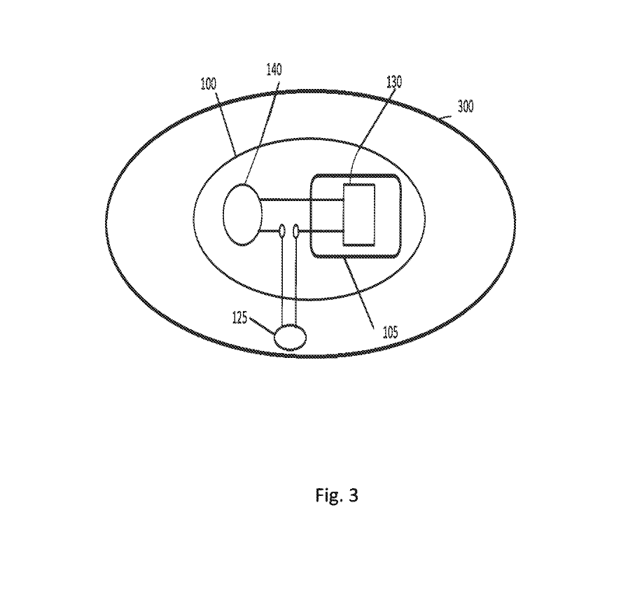

As shown in FIG. 1, a system 1000, comprises an absorbent article 300, and an interrogator 200. The absorbent article 300 comprises a tag 100. The tag 100 includes a removable portion comprising a chip 130, and a second portion including: a conductive polymer system 125 and an antenna 140. The interrogator 200 comprises a sensor 210, a power source 220, an antenna 230, an analysis element 240, a display element 250, and a network link 260. As shown in FIG. 2, the absorbent article 300 comprises a tag 100. The tag 100 includes a removable portion comprising a chip 130, and a second portion including: a conductive polymer system 125 and an antenna 140. As shown in FIG. 3, the absorbent article 300 comprises a tag 100. The tag 100 includes a removable portion comprising a chip 130, and a second portion including: a conductive polymer system 125 and an antenna 140.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm ”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A sensor system comprising a tag, the tag comprising:
a. a least one removable radio-frequency chip comprising a memory element, the memory element comprising electrical storage of a binary coded word comprising at least one bit, and output terminals;
b. at least one conductive polymeric system disposed in electrical communication with at least one output terminal of the chip and adapted to change electrical state in association with a predetermined change in an environment of the conductive polymeric system;
c. a first antenna disposed in electrical communication with the output terminals of the chip and the conductive polymeric system.

2. The sensor system of claim 1 further comprising an interrogator comprising a power source and a second antenna adapted to generate electromagnetic radiation comprising a resonant frequency of the first antenna, and a receiver adapted to detect electromagnetic radiation and de-modulate the detected radiation extracting embedded data from the detected radiation.

3. The sensor system of claim 2 wherein the interrogator further comprises: an analysis element adapted to interpret the extracted embedded data, and a display element adapted to display the results of the interpretation.

4. The sensor system of claim 2 wherein the interrogator further comprises a sensor.

5. The sensor system of claim 2 wherein the interrogator further comprises a network communications link.

6. The sensor system of claim 1 wherein the first antenna comprises an omni-directional antenna.

7. The sensor system of claim 1 further comprising a product wherein the tag comprises part of the product.

8. The sensor system of claim 1 wherein the product comprises a disposable absorbent article.

9. The sensor system of claim 8 further comprising electrical shielding disposed between the antenna and product.

10. The sensor system of claim 9 wherein the shielding comprises part of the tag.

11. The sensor system of claim 1 wherein the product comprises a package containing a consumable good.

12. The sensor system of claim 1 wherein the product comprises a portable power source.

13. The sensor system according to claim 1 wherein the tag comprises a passive radio frequency chip.

14. A method of determining product information, the method comprising steps of:
a. providing a product comprising a tag including a removable chip, a state of the tag associated with a state of a conductive polymeric system;
b. providing an interrogator adapted to detect radiation associated with the bit of the tag;
c. altering the environmental state of the tag with respect to the environment of the conductive polymeric system;
d. interrogating the state of the tag after the environment of the conductive polymeric system has been altered;
e. interpreting the state of the tag;
f. providing an output associated with the interpreted state of the tag.

15. The method according to claim 14 wherein the step of providing an interrogator further comprises providing an interrogator comprising a network communications link, the method further comprising step of sharing the interpreted state of the tag over a network.

16. The method according to claim 15 further comprising the step of sharing data from the interrogator sensor over the network.

17. The method according to claim 15 further comprising the step of purchasing a unit of the product using the network.
